(19) United States
(12) Patent Application Publication
(10) Pub. No.: US 2010/0000337 A1
(43) Pub. Date: Jan. 7, 2010

(54) Sensor with Resistance Layer

(76) Inventor: Wolfgang J. Wiedemann, Kaufbeuren (DE)

Correspondence Address: JACOBSON HOLMAN PLLC, 400 SEVENTH STREET N.W., SUITE 600, WASHINGTON, DC, 20004, US

(21) Appl. No.: 12/084,145

(22) PCT Filed: Oct. 26, 2006
(86) PCT No.: PCT/EP2006/010341

§ 371 Date: May 11, 2009

(30) Foreign Application Priority Data
Oct. 28, 2005 (DE) 102005052087.1

(51) Int. Cl. G01L 1/22; G01L 9/04

(52) U.S. Cl. 73/862.627; 73/726

(57) ABSTRACT

The invention refers to a sensor, consisting of a substrate carrying a resistive coat, the resistive coat consisting of titanium-wolfram-nitrite (Ti_{z}W_{1-z}N).

The invention refers to a sensor consisting of a substrate and a resistive coat.

The use of sensors for determining physical data is sufficiently known. Usually the sensor has a substrate. The substrate is held in a suitable way or is integrated in the sensor housing.

The substrate carries a resistive coating. The voltage dropping because of its electrical resistance at this resistive coat can be read out in a suitable way, and is, with a suitable arrangement, a measure for the physical parameter which has to be measured by the sensor. Thus it is, for example, known to integrate suitable wire strain gauges in sensors in order to realise a sensor for measuring force or pressure. Here the force or pressure to be measured acts on the substrate which is designed, for example, as membrane. The extension of the membrane leads to an extension of the resistive coat of the wire strain gauge so that the electric resistance changes, in particular increases, in a measurable way.

It is now desirable to provide sensors which can be used in difficult environmental conditions (for example pressure, temperature, humidity, gas composition and so on). There is therefore a number of different suggestions which materials the resistive coats consist of in order to measure corresponding physical properties.

Thus, for example, in the German specification 35 22 427 the use of titanium-oxy-nitrite (TiOₓN_{y}) is described as resistive coat of a film resistor for wire strain gauges. The ratio of oxygen and nitrogen in this known compound allows adjusting some properties of this sensor, in particular if it is used as pressure sensor.

From the German application DE 199 28 291 A1 a sensor structure and a method for connecting isolated structures is known where a sensor uses a conductive bridge in order to bridge an open gap for the electric connection between structures in an integrated circuit. Such a conductive bridge is useful with sensors where it is necessary to measure electric properties like differential capacities between electrically isolated structures. The structures here are electrically isolated by forming an open gap around the sides. The bottom of the structures is electrically isolated by an oxide film. The conductive bridge is here formed, for example, by filling the gaps with sacrificial glass in order to provide a stable base across which the polysilicon conductors have to laid, in order to remove then the sacrificial glass to form conductive bridges across the open gap. The open gaps provide the required isolation, and the conductive bridges provide the required electric connection.

In the US specification 2003/0108664 A1 also a composition and a method for improving the mechanic and electric properties of electronic components, as described before, is known. In this document a number of original compositions is described which can be put in or applied to electric components. These original compositions are characterised by a low conversion temperature.

It is desirable here that the temperature coefficient of the resistor is as low as possible, that means independent from the temperature of the substrate or the resistive coat. The result is namely that, independent from the application temperature of the pressure sensor, always the actual data, (for example pressure) are measured. A complicated correction algorithm because of the temperature drift can then be done without.

Another important characteristic of the resistive coats used as wire strain gauge is the gauge factor which is also described as K-factor.

The resistive coats of known sensors are applied, for example, in a sputter process. Nitrogen with low partial pressure (for example ca. 4×10⁻² Pa) is added to the sputter gas, preferably argon. The target material is conveniently, for example, titanium. In order to produce the known titanium-oxynitrite-compound during the application process, the sputtering, beside nitrogen also a certain concentration of oxygen is added. Now the binding behaviour of oxygen differs largely from the one of nitrogen and the risk is that the oxygen is deposited preferably in the deposited resistive coat like the nitrogen, and thus comparatively inhomogeneous layers are formed. The result of that are properties of the sensor which are difficult to control (for example K-factor or temperature dependence of the resistor).

Thus it is an object of the invention to improve the sensors as described in the beginning.

In order to solve this problem the invention suggests a sensor as described in the beginning, wherein the resistive coat consists of titanium-wolfram-nitrite (Ti_{z}W_{1-z}N)

The advantage of the invention is that in this embodiment oxygen in the resisitive coat is not needed. Because of the mixing ratio of titanium and wolfram (content z) the properties of the sensor, in particular the K-factor, but also the temperature coefficient of the resistor, can be adjusted. However, the invention does not exclude here that in such a compound, suggested according to the invention, consisting of titanium, wolfram and nitrogen (in the following also called nitrite) in one modification also oxygen is added. By adding oxygen, in particular as (part) substitute element for nitrogen, other adjustment parameters for the properties of the sensor are reached improving the pressure sensor, as required according to the invention, that means they make it optimally adjustable for the different fields of application.

Therefore the invention here comprises expressly also these compounds where the resistive coat only consists of the components titanium-wolfram-nitrite, or other elements are added to this basic compound titanium-wolfram-nitrite.

In contrast to the solutions known from the state of the art the sensor according to the invention is characterised in that the resistive coat consists of titanium-wolfram-nitrite (Ti_{z}W_{1-z}N). None of the solutions known from the state of the art shows such a film of titanium-wolfram-nitrite which can be used in particular in sensors, for example as pressure sensor or force sensor or as wire strain gauge. In contrast to the state of the art here the resistive coat can be produced in particular simpler, and does not consist of the very complicated structures of the construction of such sensors required in the state of the art, which require, for example, conductive bridges across open gaps in the electric components. The production process of elements of this type is therefore made essentially easier by the solution according to the invention.

It has been found that the electric properties of this resistive coat consisting of titanium-wolfram-nitrite can actually be well controlled and be used in the use of the sensor, in order to realise in particular pressure sensors which are even stable at high temperatures the substrates will be exposed to (up to 350° C.).

In a preferred modification of the invention it is therefore provided that the sensor is designed as pressure sensor or as force sensor. In such a design then the substrate is in connection with the medium the pressure or force development of which has to be measured. Thus, for example, the substrate is shaped like a membrane in order to realise a pressure sensor. Here cleverly the resistive coat is arranged at the substrate side opposite the medium in order to protect it, for example, against too strong heat impact and so on as well as possible. It is also possible by means of that that the electric feed and derivation are protected from the pressure space. It has namely to be taken into consideration here that the pressure space, for example in an internal combustion engine, contains hot, even reactive gases which may attack the electric contacts or even the resistive coat chemically.

It has proved convenient that the invention provides that the resistive coat serves as wire strain gauge. When the shape of the substrate changes geometrically so that it can be discerned accordingly the resistive coat is extended or upset so that the electric properties, in particular the resistance, is changed. When the current flow through the resistive coat is constant therefore, therefore the voltage dropping at the resistive coat is changed which then is a measure for the extension or upsetting of the substrate (for example the membrane), and thus a measure for the pressure or the force.

Measuring arrangements of this type are sufficiently known. They are often realised in the form of a Wheatstone bridge.

In the use of the invention as force sensor it is provided that the substrate is connected in a suitable way with the means the force development of which has to be measured. Here also the impressing of the force, similar to a pressure sensor, will lead to a deformation of the substrate which can be measured in the wire strain gauge.

In a preferred modification of the invention it is provided that the share of wolfram in the element pair titanium-wolfram of the resistive coat is >50%, that means z <½. It has been found that, with a wolfram content in the given compound of more than 50%, the temperature coefficient of the resistor can be set through the titanium-wolfram ratio and the nitrogen share to zero. Such a modification disengages the pressure sensor from a temperature dependence, and makes evaluating the measure signals much more easier. Another advantage of this modification is in particular that the films applied accordingly are more stable, and simple processes can be used as it is not necessary to work with the highly reactive oxygen. The advantage described before does not refer exclusively to resistive coats consisting only of titanium-wolfram-nitrite but also to the modifications according to the invention described in the following.

In another convenient embodiment of the invention it is provided that in the resistive coat a part of the nitrogen atoms is substituted by a substitute element A, and the compound Ti_{z}W_{1-z}AₓN_{y} is the result. It has been found that it is possible to get another adjustment choice in the titanium-wolfram-nitrite compound by a partial substitution of the nitrogen atoms by substitute elements. It has been found that by varying the ratios of shares of the substitute element and the nitrogen also the properties of the sensor, in particular its temperature coefficient, but also the K-factor or the temperature dependence of the K-factor can be adjusted.

The invention leaves it open here whether a univalent, bivalent, trivalent or quadrivalent substitute element A is used. Depending on the way the resistive coat has been produced it is possible to integrate also the substitute element A in the film. It is, for example, possible, to produce the substitute element A as additional target in the sputter process, and to deposit it on the substrate. However, it is also possible to use the substitute element A in gas form, for example as addition to the sputter gas. Basically, each applying process, be it sputtering, reactive evaporation of ion platers, pyrolytic depositing (CVD) or laser sputtering, offers the chance to integrate one or even more substitute elements in the resistive coat. All processes mentioned before are processes of the thin-film technology and suited for applying the resistive coat as thin film to the substrate.

Very good successes have been reached here with oxygen as substitute element. The result is then a titanium-wolfram-oxygen (Ti_{z}W_{1-z}OₓN_{y}) compound.

It is pointed out here that the exchange of nitrogen by oxygen atoms is not in contrast to the invention as the subject matter of the invention is not to avoid the more reactive oxygen but to improve the properties of the sensor. In this development according to the invention the positive properties of titanium-wolfram-nitrite compounds are, as described above, combined with the fact that the temperature coefficient of the K-factor becomes as low as possible.

The invention is here not limited only to the effect of choosing the K-factor as low as possible but to set in particular the K-factor such that the temperature depending effects of the substrate, in particular its temperature dependence of the elasticity module is compensated if possible. The result is that by means of the embodiment according to the invention it is achieved that the properties of the complete sensor are as temperature independent as possible.

Therefore an almost neutral temperature coefficient of the resistor or the sensor is reached. This effect is achieved already with a low wolfram share, however, it improves considerably when the wolfram share rises over 50%.

A resistive coat or sensor designed in this way according to the invention is characterised by a basically adjustable K-factor the temperature coefficient of which is as low as possible, and where the temperature coefficient of the resistor is also very low or zero.

In a preferred modification of the invention it is provided that the titanium-wolfram-substitute-element-nitrogen compound (Ti_{z}W_{1-z}AₓN_{y}) of the resistive coat has a low share of wolfram, that means z >0.8, in particular preferred z >0.9.

In connection with the compound titanium-wolfram-nitrogen-oxygen (Ti_{z}W_{1-z}OₓN_{y}) the modification with z=1 is excluded explicitly as this corresponds with the state of the art. Commonly therefore goes that 0 <z <1.

When the wolfram share is very low the result is that the stability of this mesh effect improves. Also the dimension and the temperature coefficient of the K-factor can already be influenced by that. As titanium-nitride (TiN) as well as wolfram-nitride (WN) have a fcc lattice the mesh effect is not destroyed when wolfram is accordingly integrated in this combination. Rather a homogeneous distribution of components is obtained, the forming of wolfram-nitride grains in the titanium-nitride matrix is prevented. The temperature coefficient of the resistor is adjusted by a controlled and monitored addition of oxygen to the sputter gas (nitrogen) by substitution.

It has proved to be convenient that in the titanium-wolfram-substitute-element-nitrogen compound the element pair substitute element-nitrogen (AₓN_{y}) is contained in the following connection (1<=x+y <=2).

In a preferred modification of the invention it is suggested that metal, in particular metal alloys are used as substrate material. Preferably, for example, steel or steel alloys are used. The substrate is, for example, designed membrane-like when used as pressure sensor. It is possible here that the substrate can be formed sufficiently thin so that all material changes caused by pressure can actually also be measured.

Basically, it is possible to apply the resistive coating to each solid body. It is, for example, provided to use as substrate material titanium, lithium (Li) or even synthetic materials (for example at low temperatures). It is, of course, also possible to use ceramic materials, like for example Al₂O₃ as substrate material as well as other ceramic materials.

Good results have also been reached with nickel-chrome-base alloys as substrate material.

The use of steel, for example 17-4 PH steel is convenient when correspondingly aggressive fields of use are planned for the sensor. This steel mentioned before is characterised by a high ability to be deformed elastically. Steels of this kind have sufficiently resistance against corrosion or acids, and can also be used with inconvenient marginal conditions.

It is convenient when between the substrate and the resistive coat a barrier film is provided. Such a barrier film is in particular designed as electric isolator in order to avoid a short circuit which might occur otherwise. Besides the task of providing an electric isolation the barrier film can also have alternatively another/additional purpose. It is, for example, provided that the barrier film forms as buffer film or adhesive film as a stable connection between the lattice of the substrate and the lattice of the resistive coat.

It is convenient that the resistive coat is coated by a gas inhibitory or gas impermeable, in particular oxygen inhibitory or oxygen impermeable passivation film. It has been noticed that the chemical composition of the resistive coat changes because of the considerable temperature load of the resistive coats if these are used, for example, as pressure sensors in the combustion chambers of internal combustion engines. Vice versa it has been noticed that the oxygen share changes, in particular increases. Thus unprotected resistive coats are at risk that the properties of the pressure sensor changes to the worse, in particular the temperature dependence of the resistor or the K-factor adjusted through the choice of the oxygen or nitrogen share. If now the resistive coat is coated by a suitable passivation film which can be applied in the same or a similar working step to the resistive coat as the production of the resistive coat, the resistive coat is protected reliably. Besides an electric isolation quality the passivation film only needs a similar expansion behaviour as the resistive coat to be protected.

As passivation film here, for example, Si₃N₄, SiO₂, AlN, Al₂O₃, TiO₂ is suggested. Of course, also other known compounds can be used which effect a suitable isolation or passivation.

Furthermore it is advantageously suggested that the resistive coat is connected with contact surfaces electrically conducting. The contact surfaces here consist preferably of Ni, TiAu, TiAg, CrAg, TiPtAu, CrAu, CrPdAg, NiAu, NiAg. On the one hand, the before mentioned materials are characterised in that it is possible that suitable connecting lines can be bonded to them, and thus there is a good electric contact. On the other hand, the material of the contact surface is chosen in such a way that it results in a good adhering to the resistive coat. Of course, also other material combinations or compounds can be used for the contact surfaces.

The invention is not only solved by a sensor suggested according to the invention, but also by the use of a titanium-wolfram-nitrite-compound as resistive coat. The use of such a resistive coat, for example with suitable sensors, but also in other fields of use, also solves the problem formulated in the beginning.

In this connection it is, in particular, pointed out that all characteristics and properties, but also methods described in connection with the pressure sensor, can be transferred accordingly also to the formulation of the use according to the invention, and can be used according to the invention and are seen also as disclosed.

The same goes, of course, also vice versa. This means that the production processes or the use of mentioned constructive or concrete characteristics are also referred to and claimed in the frame of the characteristics aimed at the sensor, and these also are part of the invention and disclosure.

The claims filed with the application now and to be filed later on are attempted formulations without prejudice for obtaining a broader protection.

If here, on closer examination, in particular also of the prior art, it turns out that one or the. other feature may be convenient for the object of the invention, however, not decisively important, of course, already now a formulation is striven for which does not contain such a feature, in particular in the main claim.

References in the sub-claims relate to the further design of the matter of the main claim through the characteristics of the respective sub-claims. However, these are not to be understood as a waiver of independent protection of the matter for the characteristics of the referred sub-claims.

Characteristics only disclosed in the description so far, may now, in the course of proceedings, be claimed as being of inventive relevance, for example to distinguish from the state of the art.

Characteristics only disclosed in the description or even single characteristics from claims comprising a variety of characteristics may be used at any time to distinguish from the state of the art in the first claim, and this is even if such characteristics have been mentioned in connection with other characteristics, or achieve particularly convenient results in connection with other characteristics, respectively.

1-18. (canceled)

19. Sensor consisting of a substrate carrying a resistive coat, the resistive coat consisting of titanium-wolfram-nitrite (Ti_{z}W_{1-z}N).

20. The sensor according to claim 19, characterised in that the sensor is designed as pressure sensor or as force sensor.

21. The sensor according to claim 19, characterised in that the resistive coat serves as wire strain gauge.

22. The sensor according to claim 19, characterised in that the share of wolfram in the element pair titanium-wolfram of the resistive coat as more than or equal 50%, that means z <½.

23. The sensor according to claim 19, characterised in that in the resistive coat a part of the nitrogen atoms is substituted by a substitute element A, and the result is the compound Ti_{z}W_{1-z}AₓN_{y}.

24. The sensor according to claim 19, characterised in that in the resistive coat a part of the nitrogen atoms is substituted by a substitute element A, and the result is the compound Ti_{z}W_{1-z}AₓN_{y} and the substitute element A is univalent, bivalent, trivalent or quadrivalent.

25. The sensor according to claim 19, characterised in that in the resistive coat a part of the nitrogen atoms is substituted by a substitute element A, and the result is the compound Ti_{z}W_{1-z}AₓN_{y} and as substitute element oxygen is provided, and the result is a titanium-wolfram-oxy-nitrite (Ti_{z}W_{1-z}OₓN_{y}).

26. The sensor according to claim 19, characterised in that in the resistive coat a part of the nitrogen atoms is substituted by a substitute element A, and the result is the compound Ti_{z}W_{1-z}AₓN_{y} and in the titanium-wolfram-substitute-element-nitrogen-compound of the resistive coat preferably a low content of wolfram, that means z >0.8, in particular z >0.9, is provided.

27. The sensor according to claim 19, characterised in that in the resistive coat a part of the nitrogen atoms is substituted by a substitute element A, and the result is the compound Ti_{z}W_{1-z}AₓN_{y} and in the titanium-wolfram-substitute-element-nitrogen-compound of the resistive coat the element pair substitute element (Aₓ)/nitrogen (N_{y}) is contained in the following compound:
1<=x+y <=2

28. The sensor according to claim 19, characterised in that in the resistive coat a part of the nitrogen atoms is substituted by a substitute element A, and the result is the compound Ti_{z}W_{1-z}AₓN_{y} and as substrate material metal, metal alloys, in particular steel or steel alloys, are provided.

29. The sensor according claim 19, characterised in that between the substrate and the resistive coat a barrier layer is provided.

30. The sensor according to claim 19, characterised in that the resistive coat is coated by a gas inhibitory or gas impermeable, in particular oxygen inhibitory or oxygen impermeable, passivation layer.

31. The sensor according to claim 19, characterised in that the resistive coat is coated by a gas inhibitory or gas impermeable, in particular oxygen inhibitory or oxygen impermeable, passivation layer and the passivation layer consists of Si₃N₄, SiO₂, AlN, Al₂O₃, TiO₂.

32. The sensor according to claim 19, characterised in that that the resistive coat is coated by a gas inhibitory or gas impermeable, in particular oxygen inhibitory or oxygen impermeable, passivation layer and the resistive coat is connected electrically conducting with contact surfaces, and the contact surfaces consist of Ni, TiAu, TiAg, CrAg, TiPtAu, CrAu, CrPdAg, NiAu, NiAg.

33. The sensor according to claim 19, characterised in that the resistive coat is applied in thin-film technology to the substrate.

34. Use of a titanium-wolfram-nitrogen-compound (Ti_{z}W_{1-z}N) as resistive coat.

35. The use according to claim 34, characterised in that in the titanium-wolfram-nitrogen-compound a part of the nitrogen atoms is substituted by a substitute element, in particular oxygen.

36. The use according to claim 34, characterised by a use of the resistive coat as wire strain gauge.
